(19) United States
(12) Patent Application Publication
(10) Pub. No.: US 2023/0058244 A1
(43) Pub. Date: Feb. 23, 2023

(54) CONTACTLESS POWER FEEDING DEVICE

(71) Applicant: TOSHIBA TEC KABUSHIKI KAISHA, Tokyo (JP)

(72) Inventor: Yasuhiro KATABIRA, Tagata Shizuoka (JP)

(21) Appl. No.: 17/831,383

(22) Filed: Jun. 2, 2022

(30) Foreign Application Priority Data
Aug. 23, 2021 (JP) 2021-135319

(51) Int. Cl. H02J 50/40; H02J 50/10; B62B 3/00; B62B 3/18

(52) U.S. Cl. CPC H02J 50/40; H02J 50/10; B62B 3/005; B62B 3/18; B62B 3/1424

(57) ABSTRACT

A contactless power feeding device for charging a battery disposed on a cart by contactless power feeding includes a plurality of first power feeding units in a row along a first direction. Each includes a power transmitter configured to transmit electric power to a power receiver attached to a cart. The device has plurality of tracks along which wheels of the cart move, and a housing connected to the one of the first power feeding units located at an end of the row. The housing includes a surface that serves as an end of each of the tracks. A first relay board is in the housing and configured to relay electric power from an external power supply to the plurality of first power feeding units.

### CROSS-REFERENCE TO RELATED APPLICATION

This application is based upon and claims the benefit of priority from Japanese Patent Application No. 2021-135319, filed Aug. 23, 2021, the entire contents of which are incorporated herein by reference.

### FIELD

Embodiments described herein relate generally to a contactless power feeding device and a contactless power feeding system.

### BACKGROUND

In retail stores such as a supermarket, shopping carts are widely used for the customers to store merchandise items therein. To improve convenience for customers, it has been considered to attach to such a shopping cart a merchandise registration device for reading and registering merchandise information that can identify a merchandise item.

When such a registration device is attached to a shopping cart, there generally needs to be a mechanism to charge a battery of the registration device. One example of such a mechanism is a contactless power feeding device installed in the store and transmitting electric power towards the cart by a contactless power feeding method.

However, the scale of the contactless power feeding device installed in the store varies, depending on the circumstance of each store. That is, how many registration devices or carts need to be charged varies from one store to another. Therefore, a contactless power feeding device that can adjust the number of carts to be charged according to store preference has been developed.

However, the conventional contactless power feeding device can generally only change the number of carts to be charged increments of two or more, and the installation space for the power feeding device in the store may end up being insufficient or wasted. Therefore, it is desired that the power feeding device can change the number of carts to be charged more flexibly, such as an in increments of one.

A power feeding device can be achieved by having detachable charging units that can be added or removed depending on the demand. However, such a power feeding device would typically require a large number of separate AC adaptors and power cables having a different length depending on the installation location of the power feeding device and the individual charging units and the physical space available for the power feeding device

### BRIEF DESCRIPTION OF THE DRAWINGS

FIG. 1 is a perspective view showing a contactless power feeding system according to an embodiment.

FIG. 2 is a perspective view showing an external appearance of a cart.

FIG. 3 is a plan view showing a structure of a contactless power feeding device.

FIG. 4 is a schematic view showing an assembly state of a stop unit and a power feeding unit.

FIG. 5 is a schematic view showing an assembly state of a stop unit and a power feeding unit according to Modification Example 1.

FIG. 6 is a schematic view showing an assembly state of a stop unit and a power feeding unit according to Modification Example 2.

### DETAILED DESCRIPTION

One or more embodiments described herein provide a contactless power feeding device for supplying electric power to merchandise registration devices attached to shopping carts for which the total number of shopping carts that can be charged at any one time can be changed in single cart increments.

In general, according to one embodiment, a contactless power feeding device for charging a battery disposed on a cart by contactless power feeding is provided. The power feeding device comprises a plurality of first power feeding units in a row along a first direction, each including a power transmitter configured to transmit electric power to a power receiver attached to a cart. A plurality of tracks along which wheels of the cart move is provided in the device. The power feeding device further comprises a housing connected to a first power feeding unit of the plurality that is located at an end of the row. The housing provides a surface that is an end of each of the tracks. The power feeding device further comprises a first relay board in the housing that is configured to relay electric power from an external power supply to the plurality of first power feeding units via one or more cables or the like.

Certain example embodiments will now be described using the drawings. The example embodiments discussed below generally concern a contactless power feeding device for charging merchandise registration devices mounted on a shopping cart or the like, but the disclosure is not limited thereto. The contactless power feeding device and each component described below are specific application examples of a contactless power feeding device feeding electric power to a cart or other mobile apparatus equipped with rechargeable battery or an electronic device mounted or otherwise incorporated thereon or therein

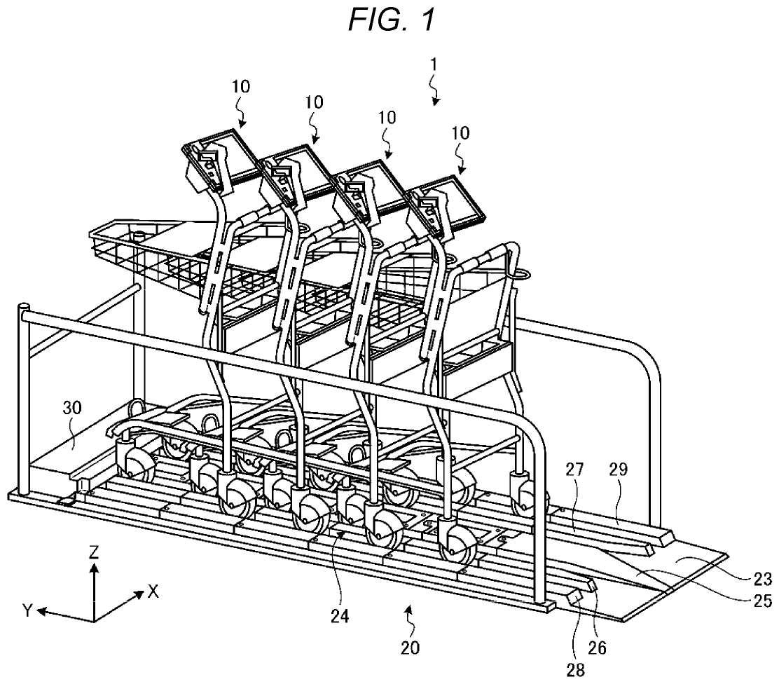

FIG. 1 is a perspective view showing a contactless power feeding system 1 according to an embodiment. The contactless power feeding system 1 includes a cart 10 and a contactless power feeding device 20. FIG. 1 shows a case where the contactless power feeding device 20 is installed at a retail store in a cart storage area where carts 10 are placed when not in active use by customers or the like.

In FIG. 1, a three-dimensional coordinate system is shown in order to facilitate the understanding of the structure. The direction of the width of the contactless power feeding device 20 is defined as X-axis direction. The direction along which the cart 10 enters and exits the contactless power feeding device 20 is defined as Y-axis direction. The direction of the height is defined as Z-axis direction. With respect to the entry and exit of the cart 10 in and out of the contactless power feeding device 20, the cart 10 is considered to be moved forward for entry and moved backward for exit. The positive direction along the Y-axis is considered the forward direction of the cart 10. The negative direction along the Y-axis is considered the backward direction of the cart 10.

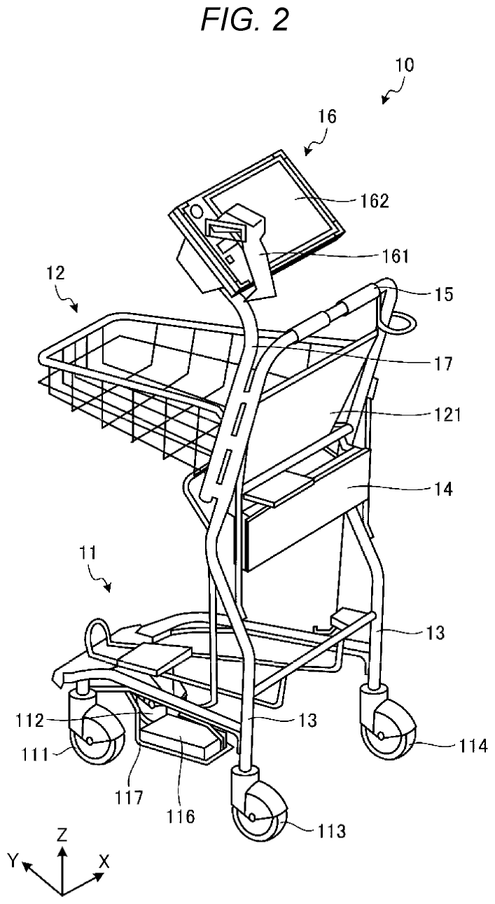

FIG. 2 is a perspective view showing the external appearance of the cart 10. At a retail store, such as a supermarket, a customer places a collected merchandise item to be purchased in the cart 10. The cart 10 is a pushcart pushed and moved by the customer.

More specifically, the cart 10 has a base unit 11 for movement. The base unit 11 has a pair of front wheels 111, 112 and a pair of rear wheels 113, 114. The space between the front wheel 111 and the front wheel 112 is narrower than the space between the rear wheel 113 and the rear wheel 114. An attachment unit 117, to which a power receiver 116 for receiving electric power via contactless power feeding is attached, is arranged below the base unit 11. The power receiver 116 is arranged to be substantially horizontal.

The cart 10 has an open-top basket-like container unit 12 above the base unit 11. The container unit 12 is supported by a support pole 13 extending from the base unit 11. In the container unit 12, a plate 121 on the rear side can open towards the forward direction of the cart 10. Thus, the container unit 12 of one cart 10 can be inserted into the container unit 12 of another cart 10 from behind, as shown in FIG. 1, and therefore multiple carts can be put together and nested in one direction to save space. In some examples, the carts 10 may not incorporate container unit 12 as an integral component. For example, the cart 10 may instead have a basket holding unit that holds a detachable shopping basket for storing merchandise items, and the detachable shopping basket may be used as the container unit 12 while attached to the cart 10.

A holder 14 containing a secondary battery can be arranged below the container unit 12. The secondary battery is charged with the electric power received by the power receiver 116.

The support pole 13 has a handle part 15 that may be gripped by the customer moving the cart 10. A support unit 17 supporting a merchandise registration device 16 for registering a merchandise item is attached to the support pole 13.

The merchandise registration device 16 is a device for registering merchandise for purchase. The merchandise registration device 16 has a scanner 161 and a display unit 162. The scanner 161 reads information from a merchandise item. The scanner 161 reads, for example, a merchandise code that is expressed by a barcode or the like and that can identify a merchandise item. The display unit 162 is a touch panel display, for example. The display unit 162 displays, for example, an image of a merchandise item read by the scanner 161. The merchandise registration device 16 is driven by the electric power supplied from the secondary battery contained in the holder 14.

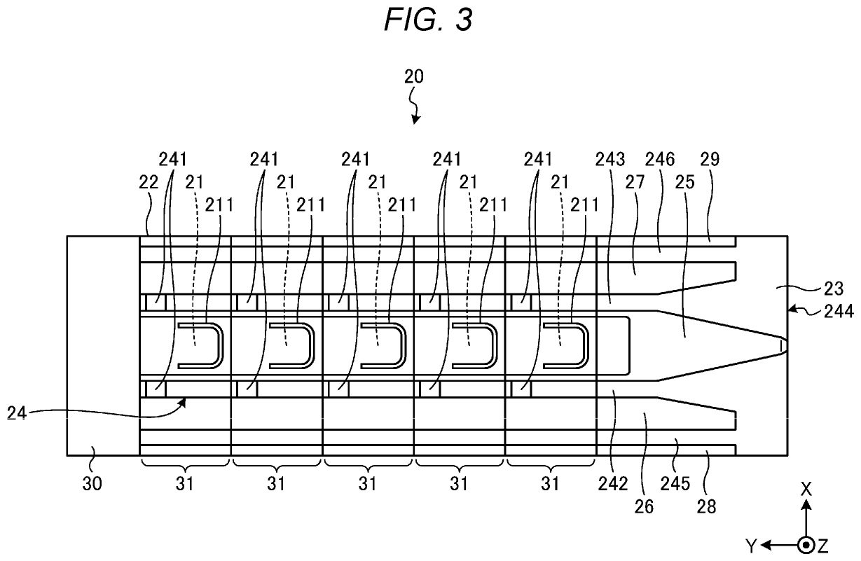

FIG. 3 is a plan view showing a structure of the contactless power feeding device 20. The contactless power feeding device 20 has a power transmitter 21, a housing 22, a slope part 23, a placement unit 24, a center wheel guide rail 25, a first front wheel guide rail 26, a second front wheel guide rail 27, a first rear wheel guide rail 28, a second rear wheel guide rail 29, and a stopper 30.

The power transmitter 21 transmits electric power by contactless power feeding to the power receiver 116 of the cart 10. The efficiency of power feeding to the power receiver 116 by this power transmission drops if the power receiver 116 of the cart 10 is not at a position facing the power transmitter 21 of the contactless power feeding device 20. Therefore, the contactless power feeding device 20 has a configuration in which the cart 10 can be easily arranged at such a position that the power receiver 116 and the power transmitter 21 face each other.

The housing 22 houses one or more power transmitters 21 therein. The housing 22 has a light-emitting unit 211 at a position equivalent to the periphery of the power transmitter 21. For example, the light-emitting unit 211 is a light-emitting diode (LED) that emits light if the power receiver 116 is at the position facing the power transmitter 21. Thus, a store clerk or the like of the retail store can identify whether the cart is charged by contactless power feeding. FIG. 3 shows, as one example, the contactless power feeding device 20 having five power transmitters 21 and five light-emitting units 211.

The housing 22 has a thickness that is large enough for the power transmitter 21 to be built therein. The slope part 23 is provided at a rear end part of the housing 22 and has a sloped top surface inclined to increase in height as it goes in the positive direction along the Y-axis. Such a slope part 23 helps the cart 10 entering the device 20 to go onto the housing 22.

The placement unit 24 is provided at a position rising from the slope part 23, on the top surface of the contactless power feeding device 20. The placement unit 24 is an area where the cart 10 having the merchandise registration device 16 and the power receiver 116 receiving electric power to be supplied to the merchandise registration device 16 is placed. The carts 10 on the placement unit 24 are put together along one direction and thus nested in this state.

The power transmitter 21 is installed substantially horizontally at the position facing the power receiver 116, in the placement unit 24, and generates a magnetic field in the vertical direction. In this way, the power transmitter 21 transmits electric power to the power receiver 116 of the cart 10 by contactless power feeding. Various methods of contactless power feeding such as electromagnetic induction and magnetic resonance are known. Any contactless power feeding method can be used.

In this disclosure, the term “contactless” refers to power transmission without wire-to-wire connections or the like, such as when power is wirelessly transmitted across a gap or space between power transmitter 21 and power receiver 116. However, even if, for some reason, the power transmitter 21 and the power receiver 116 do contact each other at the time of power feeding, the power transmission may still be considered “contactless” if power transmission between power transmitter 21 and power receiver 116 is not via a wired, direct connection between these components.

In order to arrange the power 21 and the power receiver 116 at the positions facing each other, the cart 10 also needs to be placed at a proper position in the contactless power feeding device 20 in the direction of the width that is orthogonal to the direction of entry of the cart 10, that is, in the X-axis direction.

The center wheel guide rail 25 is a protruding part arranged substantially at the center in the direction of the width of the contactless power feeding device 20 and extending over the entire area in front-back direction (Y-axis direction). The center wheel guide rail 25 increases in width as it goes from the rear end side (entry side for the cart 10) toward the front end side. In the placement unit 24, the center wheel guide rail 25 has a width that is substantially the same as the width from the front wheel 111 to the front wheel 112 of the cart 10. The center wheel guide rail 25 having such a shape restricts the position or movement of the cart 10 in the direction of the width of the front wheels 111, 112. That is, the center wheel guide rail 25 restricts the position of the cart 10 in the X-axis direction in the contactless power feeding device 20.

The first front wheel guide rail 26 and the second front wheel guide rail 27, and the first rear wheel guide rail 28 and the second rear wheel guide rail 29, are protruding parts arranged on the lateral sides in relation to the direction of entry of the cart 10 in the center wheel guide rail 25. These guide rails 26 to 29 extend from the rear end side (which is the entry side for the cart 10) to the front end side of the placement unit 24.

The space between the first front wheel guide rail 26 and the second front wheel guide rail 27 becomes broader as it goes from the rear end side towards the placement unit 24. In the placement unit 24, the first front wheel guide rail 26 has a width that is substantially the same as the difference between the positions of the front wheel 111 and the rear wheel 113 of the cart 10 in the X-axis direction. In the placement unit 24, the second front wheel guide rail 27 has a width that is substantially the same as the difference between the positions of the front wheel 112 and the rear wheel 114 of the cart 10 in the X-axis direction.

The space from the inner side of the first front wheel guide rail 26 to the center wheel guide rail 25 has a width that is substantially the same as the width of the front wheel 111. The space from the inner side of the second front wheel guide rail 27 to the center wheel guide rail 25 has a width that is substantially the same as the width of the front wheel 112.

The width from the outer side of the first front wheel guide rail 26 to the outer side of the second front wheel guide rail 27 is substantially the same as the width from the rear wheel 113 to the rear wheel 114 of the cart 10.

The space between the first rear wheel guide rail 28 and the second rear wheel guide rail 29 has the same width over the entire area in the front-back direction. The space from the inner side of the first rear wheel guide rail 28 to the first front wheel guide rail 26 has a width that is substantially the same as the width of the rear wheel 113. The space from the inner side of the second rear wheel guide rail 29 to the second front wheel guide rail 27 has a width that is substantially the same as the width of the rear wheel 114.

The width from the inner side of the first rear wheel guide rail 28 to the inner side of the second rear wheel guide rail 29 is substantially the same as the width from the rear wheel 113 to the rear wheel 114 of the cart 10.

The first front wheel guide rail 26, the second front wheel guide rail 27, the first rear wheel guide rail 28, and the second rear wheel guide rail 29, having such shapes, restrict the positions of the front wheels 111, 112 and the rear wheels 113, 114 of the cart 10 in the direction of the width. Therefore, the center wheel guide rail 25, the first front wheel guide rail 26, the second front wheel guide rail 27, the first rear wheel guide rail 28, and the second rear wheel guide rail 29 can restrict the position of the cart 10 in the direction of the width in the contactless power feeding device 20 when the cart 10 is placed on the placement unit 24. That is, the contactless power feeding device 20 can restrict the position of the cart 10 in the X-axis direction.

The width of the gap between the center wheel guide rail 25 and the first front wheel guide rail 26 is substantially the same as the width of the front wheel 111. The front wheel 111 guided by the center wheel guide rail 25 and the first front wheel guide rail 26 travels through the gap between the center wheel guide rail 25 and the first front wheel guide rail 26. That is, the center wheel guide rail 25 and the first front wheel guide rail 26 together form a first front wheel traveling track 242 along which the front wheel 111 of the cart 10 travels.

Similarly, the width of the gap between the center wheel guide rail 25 and the second front wheel guide rail 27 is substantially the same as the width of the front wheel 112. The front wheel 112 guided by the center wheel guide rail 25 and the second front wheel guide rail 27 travels through the gap between the center wheel guide rail 25 and the second front wheel guide rail 27. That is, the center wheel guide rail 25 and the second front wheel guide rail 27 together form a second front wheel traveling track 243 along which the front wheel 112 of the cart 10 travels.

Also, the width of the center wheel guide rail 25, the first front wheel guide rail 26, and the second front wheel guide rail 27 increases as it goes from the entry side for the cart 10 toward the placement unit 24. In other words, the first front wheel traveling track 242 and the second front wheel traveling track 243 in the placement unit 24 have a width substantially the same as the width of the front wheels 111, 112, but expand in the direction of the width in the part where the front wheels 111, 112 enter the first front wheel traveling track 242 and the second front wheel traveling track 243. Also, the center wheel guide rail 25, the first front wheel guide rail 26, and the second front wheel guide rail 27 have a protruding shape with respect to the floor of the store.

That is, the placement unit 24 has the first front wheel traveling track 242 and the second front wheel traveling track 243, which are traveling tracks for the wheels of the cart 10, decreasing in width in the direction orthogonal to the direction of entry of the cart 10 as it goes into the direction of entry of the cart 10 from the entry side for the cart 10, where the cart 10 enters. The placement unit 24 also has an entry part 244 of the first front wheel traveling track 242 and the second front wheel traveling track 243.

In this way, the center wheel guide rail 25, the first front wheel guide rail 26, and the second front wheel guide rail 27 guide the front wheels 111, 112 of the cart 10. Therefore, the operator pushes the cart 10 into the contactless power feeding device 20 from the entry side thereof and thus can easily move the cart 10 along the first front wheel traveling track 242 and the second front wheel traveling track 243.

The placement unit 24 has a first rear wheel traveling track 245 between the first front wheel guide rail 26 and the first rear wheel guide rail 28, and a second rear wheel traveling track 246 between the second front wheel guide rail 27 and the second rear wheel guide rail 29.

In the first front wheel traveling track 242 and the second front wheel traveling track 243, a plurality of recesses 241 are provided for restricting the position of the carts 10 in the direction of entry. The recess 241 is, for example, a smoothly curved recess. This recess 241 makes it hard for the wheel of the cart 10 fitted in the recess part, that is, the front wheels 111, 112, to roll over and move. Therefore, the positioning part 241 can restrict the movement of the front wheels 111, 112. That is, the contactless power feeding device 20 can restrict the position of the cart 10 in the direction of entry, in the placement unit 24.

The stopper 30 is provided at a front end part of the contactless power feeding device 20. The stopper 30 includes a box-like housing for storing an AC adaptor or the like and has a top surface higher than the top surface of the placement unit 24. Such a stopper 30 stops the cart 10 as the front end part of the leading cart 10 traveling on the placement unit 24 reaches the stopper 30. More specifically, when the front wheels 111, 112 of the leading cart 10 traveling on the placement unit 24 reach and contact the stopper 30, the stopper 30 prevents the cart 10 from moving further forward and stops the cart 10.

The contactless power feeding device 20 illustrated in FIG. 3 includes the stopper 30, five power feeding units 31, and the slope part 23, which are coupled together. The five power feeding units 31 corresponding to the number of carts 10 that can be nested are coupled together in the direction in which the carts 10 are put together, thus forming the placement unit 24. Each power feeding unit 31 has one power transmitter 21 and light-emitting unit 211. Thus, one power feeding unit 31 transmits electric power by contactless power feeding to one power receiver 116. By increasing or decreasing the number of power feeding units 31, the number of carts 10 that can be charged by the contactless power feeding device 20 can be changed.

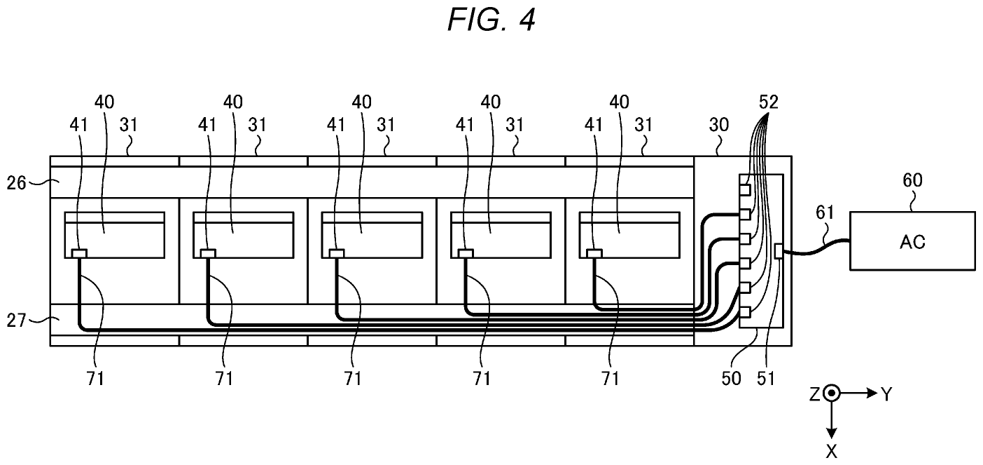

FIG. 4 is a schematic view showing an assembly state of the stopper 30 and the power feeding units 31. In this illustration, the slope part 23 provided at the rear end part of the contactless power feeding device 20 is omitted to depict other details.

Each power feeding unit 31 comprises a board 40 on which electronic components for the power transmitter 21 such as a power receiving terminal 41 is mounted.

The stopper 30 stores, in its housing, a relay board 50 relaying power from an external power supply to the power feeding unit 31. The relay board 50 is configured to relay power from an AC adaptor 60 to each board 40 and has a power receiving terminal 51 and a plurality of power transmission terminals 52. A cable 61 of the AC adaptor 60 is inserted into the power receiving terminal 51. The number of power transmission terminals 52 corresponds to the maximum number of boards 40 to which power can be transmitted, which may be set based on tolerance values or other parameters of the AC adaptor 60. A power transmission terminal 52 and a power receiving terminal 41 (on a board 40) are connected together via a relay cable 71. Each relay cable 71 is contained in the front wheel guide rail 27.

AC adaptors with various output values are commercially available. A suitable AC adaptor can be selected and used as the AC adaptor 60 from among AC adaptors with sufficient parameters for supplying the expected total electric power needs. A structure as in the related art where a separate AC adaptor 60 is connected to each power feeding unit 31 may result in an increase in redundant power capabilities due to so-called over-performance or conversely there may be a shortage of reserve power because an added AC adaptor 60 might be insufficient for supplying electric power needed by a particular power feeding unit 31. Also, in the case of a commercially available AC adaptor 60, the cable 61 provided therewith might not come in a large variety of lengths. Therefore, if there are five different distances to power feeding units 31 from an AC adaptor 60, such as shown in FIG. 4, the provided cable 61 for any one AC adaptor 60 may be too long or too short.

However, the present embodiment, each power feeding unit 31 is connected to one AC adaptor 60 via the relay board 50 and the relay cable 71 rather than directly by a separate cable 61 between each power feeding unit 31 and an individual AC adaptor 60. Thus, one length of the cable 61 can be used to connect to the relay board 50. The relay cables 71 can be more easily customized according to the required distance from a power transmission terminal 52 to a power receiving terminal 41 on each board 40.

The configuration as described above can eliminate the need for installing two or more AC adaptors when two or more power feeding units are used to feed electric power to the merchandise registration device 16 attached to the cart 10. Additionally, two or more cables for such AC adaptors having different lengths are unnecessary because one AC adaptor 60 and cable 61 may be sufficient.

The foregoing example embodiment can be implemented with various modifications by changing a part of the configuration or functions of the contactless power feeding device 20. Modification examples of the foregoing embodiment will now be described. In the description of these modification examples, differences from the already described embodiment are primarily described and additional description of those aspects that are the same or substantially similar to the already described embodiment may be omitted. These modification examples may be implemented separately or may be combined together with each where appropriate and feasible.

### Modification Example 1

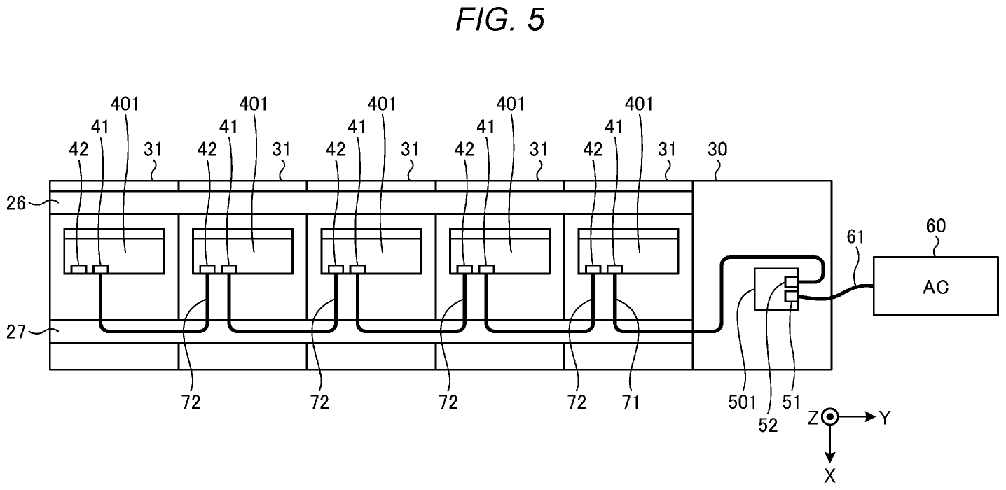

FIG. 5 is a schematic view showing an assembly state of the stopper 30 and the power feeding unit 31 according to Modification Example 1. In this modification example, each power feeding unit 31 has a board 401 instead of the board 40. The board 401 has a power transmission terminal 42 in addition to the power receiving terminal 41. The power transmission terminal 42 is configured to relay power to the power receiving terminals 41 of the board 401 in another power feeding unit 31.

In this modification example, a relay board 501 is stored in the housing of the stopper 30, instead of the relay board 50. The relay board 501 has one power receiving terminal 51 and one power transmission terminal 52. The power transmission terminal 52 is connected to the power receiving terminal 41 of the board 401 in the power feeding unit 31 next to the stopper 30, via the relay cable 71.

In this modification example, the power transmission terminals 42 and the power receiving terminals 41 of the boards 401 next to each other are connected together using four relay cables 72, each with the same length. Thus, the boards 401 are coupled together in one to one. The relay board 501 in the stopper 30 feeds electric power to the board 401 in the power feeding unit 31 next to the stopper 30.

According to this modification example, t the inconvenience of having to bundle of a large number of relay cables 71 in the rails, such as the front wheel guide rail 27, can be avoided. Thus, the operability in the installation can be improved. Also, the relay cables 72 have the same length as one another and can thus be stocked in advance and just the relay cable 71 from relay board 501 to the first board 401 needs to be customizable length.

### Modification Example 2

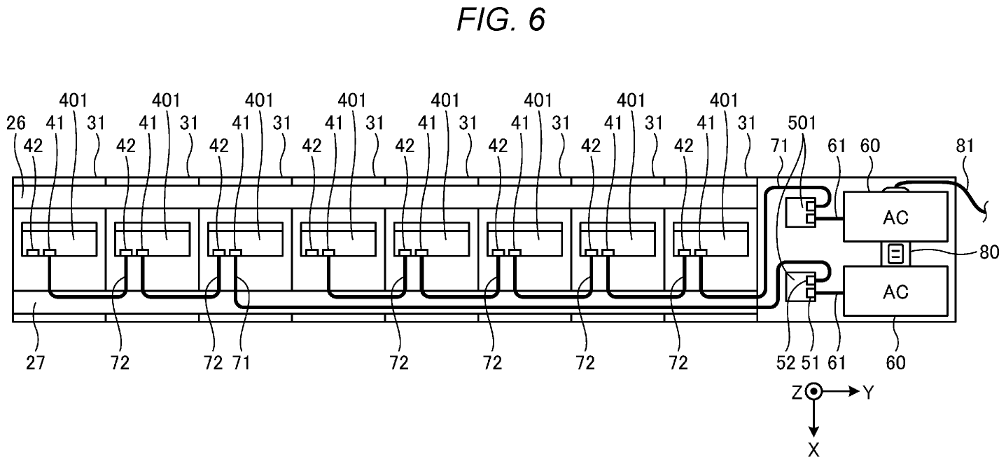

FIG. 6 is a schematic view showing an assembly state of the stopper 30 and the power feeding unit 31 according to Modification Example 2. In this modification example the contactless power feeding device 20 has more power feeding units 31 than in Modification Example 1 shown in FIG. 5.

The contactless power feeding device 20 has eight power feeding units 31, but in this example, a maximum of five power feeding units 31 may be fed from one relay board 501 due to the output of an individual AC adaptor 60. In such a case, just one relay board 501 is not enough to feed power to all eight of the power feeding units 31. Thus, an additional relay board 501 and an additional AC adaptor 60 stored in the housing of the stopper 30 are provided to feed electric power to the sixth through eighth power feeding units 31.

If a plurality of AC adaptors 60 are employed, each AC adaptor 60 may be separately connected to a power feeding socket provided in the store. However, in the depicted example, a power strip 80 that can feed electric power to the plurality of AC adaptors 60 is included within the housing of the stopper 30, as shown in FIG. 6. In such a case, it is a cable 81 from the power strip 80 that extends out from the stopper 30 to the power feeding socket or the like, rather than individual cables from each of the AC adaptors 60.

A particular number of power feeding units 31 to which electric power is supplied from one relay board 501 (in this example, five or fewer) are treated as one set and coupled together in a row. In this modification example, the first to fifth power feeding units 31 from the stopper 30 side are treated as one set and the sixth to eighth power feeding units 31 are treated as another set.

The relay board 501 feeds electric power to the board 401 in the power feeding unit 31 that is nearest to the stopper 30, of the power feeding units 31 forming each set. That is, the power transmission terminal 52 of the first relay board 501 is connected to the power receiving terminal 41 of the board 401 in the first power feeding unit 31 from the stopper 30 side, via the relay cable 71. Also, the power transmission terminal 52 of the second relay board 501 is connected to the power receiving terminal 41 of the board 401 in the sixth power feeding unit 31 from the stopper 30 side, via the relay cable 71.

The power feeding units 31 forming each set are connected together in a row as the power transmission terminals 42 and the power receiving terminals 41 of the boards 401 next to each other are connected together via the relay cables 72 with the same length.

According to this modification example, the contactless power feeding device 20 can have a greater number of power feeding units 31.

While certain embodiments have been described, these embodiments are presented simply as examples and are not intended to limit the scope of the present invention. These novel embodiments can be carried out in various other forms and can include various omissions, replacements, and modifications without departing from the spirit and scope of the present invention. These embodiments and the modifications thereof are included in the spirit and scope of the present invention and also included in the scope of the claims and equivalents thereof.

What is claimed is:

1. A contactless power feeding device, comprising:
a plurality of first power feeding units in a row along a first direction and each including:
a power transmitter configured to transmit electric power to a power receiver attached to a cart, and
a plurality of tracks along which wheels of the cart move;
a housing connected to a first power feeding unit of the plurality of first power feeding units at an end of the row, the housing including a surface that is an end of each of the plurality of tracks; and
a first relay board in the housing and configured to relay electric power from an external power supply to the plurality of first power feeding units.

2. The contactless power feeding device according to claim 1, wherein
the first relay board includes a plurality of terminals, and
each of the first power feeding units includes a terminal connected to a corresponding one of the terminals of the first relay board by a separate relay cable.

3. The contactless power feeding device according to claim 2, wherein the first relay board includes another terminal connected to the external power supply.

4. The contactless power feeding device according to claim 3, wherein the external power supply is an AC adaptor.

5. The contactless power feeding device according to claim 1, wherein
the first relay board includes two terminals,
each of the first power feeding units includes two terminals,
one of the terminals of the first relay board is connected to the external power supply,
the other of the terminals of the first relay board is connected by a first cable to one of the terminals of the first power feeding unit at the end of the row, and
the other of the terminals of the first power feeding unit at the end of the row is connected by a second cable to one of the terminals of an adjacent one of first power feeding units in the row.

6. The contactless power feeding device according to claim 5, wherein a terminal of each of the power feeding units is connected by an individual cable to a terminal of at least one adjacent power feeding unit in the row.

7. The contactless power feeding device according to claim 6, wherein each of the individual cables is the same length.

8. The contactless power feeding device according to claim 1, further comprising:
a plurality of second power feeding units located at the other end of the row; and
a second relay board in the housing and configured to relay electric power from the external power supply to at least one of the plurality of second power feeding units via a cable.

9. The contactless power feeding device according to claim 8, further comprising:
first and second AC adaptors in the housing.

10. The contactless power feeding device according to claim 9, wherein
each of the first and second relay boards includes two terminals,
each of the plurality of first power feeding units and each of the plurality of second power feeding units includes two terminals,
one of the terminals of the first relay board is connected to the first AC adaptor, and the other of the terminals of the first relay board is connected to one of the terminals of the first power feeding unit at the end of the row, and
one of the terminals of the second relay board is connected to the second AC adaptor, and the other of the terminals of the second relay board is connected to one of the terminals of the second power feeding unit that is closest to the housing.

11. A contactless power feeding system, comprising:
a plurality of carts each including:
a power receiver configured to receive electric power by contactless power feeding, and
a battery chargeable by the received power;
a plurality of first power feeding units in a row along a first direction and each including:
a power transmitter configured to transmit electric power to the power receiver, and
a plurality of tracks along which wheels of the cart move;
a housing connected to a first power feeding unit of the plurality of first power feeding units at an end of the row, the housing including a surface that is an end of each of the plurality of tracks; and
a first relay board in the housing and configured to relay electric power from an external power supply to the plurality of first power feeding units.

12. The contactless power feeding system according to claim 11, wherein
the first relay board includes a plurality of terminals, and
each of the first power feeding units includes a terminal connected to a corresponding one of the terminals of the first relay board by a separate cable.

13. The contactless power feeding system according to claim 12, wherein the first relay board includes another terminal connected to the external power supply.

14. The contactless power feeding system according to claim 13, wherein the external power supply is an AC adaptor.

15. The contactless power feeding system according to claim 11, wherein
the first relay board includes two terminals,
each of the first power feeding units includes two terminals,
one of the terminals of the first relay board is connected to the external power supply,
the other of the terminals of the first relay board is connected by first cable to one of the terminals of the first power feeding unit at the end of the row, and
the other of the terminals of the first power feeding unit at the end of the row is connected by a second cable to one of the terminals of an adjacent one of the first power feeding units in the row.

16. The contactless power feeding system according to claim 15, wherein terminal of each of the power feeding units is connected by an individual cable to a terminal of at least one adjacent power feeding unit in the row.

17. The contactless power feeding system according to claim 16, wherein each of the individual cables is the same length.

18. The contactless power feeding system according to claim 11, further comprising:
a plurality of second power feeding units located at the other end of the row; and
a second relay board in the housing and configured to relay electric power from the external power supply to at least one of the plurality of second power feeding units via a cable.

19. The contactless power feeding system according to claim 18, further comprising:
first and second AC adaptors in the housing.

20. The contactless power feeding system according to claim 19, wherein
each of the first and second relay boards includes two terminals,
each of the plurality of first power feeding units and each of the plurality of second power feeding units includes two terminals,
one of the terminals of the first relay board is connected to the first AC adaptor, and the other of the terminals of the first relay board is connected to one of the terminals of the first power feeding unit at the end of the row, and
one of the terminals of the second relay board is connected to the second AC adaptor, and the other of the terminals of the second relay board is connected to one of the terminals of the second power feeding unit that is closest to the housing.
